(19) United States
(12) Patent Application Publication
(10) Pub. No.: US 2007/0280458 A1
(43) Pub. Date: Dec. 6, 2007

(54) Caller directed voicemail response

(76) Inventors: Michael N. Aberethy, Pflugerville, TX (US); Travis M. Grigsby, Austin, TX (US); Michael A. Paolini, Austin, TX (US); Lakshmi Potluri, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/445,698

(22) Filed: Jun. 2, 2006

(51) Int. Cl. H04M 3/42

(52) U.S. Cl. 379/201.01

(57) ABSTRACT

A method, system and computer program product for enhancing a phone device such as a cell phone by automatically linking/associating caller identifying information with voicemail notification so that the phone's user (callee) receives notification of which missed call(s) generated a voicemail/SMS notification. The voicemail notification displays a notification identification (NID) associated with the particular caller number that generated the voicemail, and each voicemail displayed via the associated NID on the phone's display when the user selects the voicemail. Also, voicemail notification (icon or check mark) is added to the missed call log and displayed next to the missed call number that generated a voicemail. Additionally, granular user-directed access to voicemail is provided whereby the user of the phone device accesses the voicemail from the missed call (or received call) log and is able to listen to a specific voicemail left by a selected one of the listed missed calls/callee.

### RELATED APPLICATIONS

The present invention is related to the subject matter of commonly assigned, co-pending U.S. patent application Ser. No. 10/______ (Atty. Doc. No.: AUS920060241US1), titled: “Missed Call Integration With Voicemail and Granular Access to Voicemail,” which is filed concurrently herewith. Relevant content of that co-pending application is incorporated herein by reference.

### BACKGROUND OF THE INVENTION

1. Technical Field

The present invention relates generally to telephone systems and in particular to voicemail functions on a telephone. Still more particularly, the present invention relates to a method and system for directing voicemail response on a telephone.

2. Description of the Related Art

A growing number of conventional telephone devices are designed with intelligent functions, such as voicemail notification and missed call notification. When a received phone call is not answered by the callee, the call is flagged and recorded as a missed call in a missed call log (or the received call log in some phones). Also, typically when a call is not answered, the missed call is forwarded to voicemail, and the caller is then prompted to leave a message for the phone user (callee), who may later access and listen to the voicemail, typically at the user's convenience.

In many cases, the user is not in vicinity of the phone and/or chooses to ignore activities occurring on the phone for a period of time. During such periods, multiple missed calls may be registered, some of which may have an associated voicemail. When the user finally pays attention to the events that have occurred on his phone during that time period, the user is provided a single notification that one or more missed calls occurred and a single voicemail notification that one or more voicemails were recorded in the phone's voice mailbox. There is no correlation between the missed calls and the voicemails and no way for the user to know which voicemails are important (i.e., should be listened to) before returning the call(s).

Occasionally, the lack of association between the recorded missed calls and voicemail notification causes the user to take an incorrect action, which may lead to a wasting of the user's time or frustration of the caller's intent when leaving the call. Multiple missed calls are often recorded with only some of the callers actually leaving a voicemail. The user (callee) is thus left wondering which caller left the voicemail and whether he should listen to the voicemail before returning a missed call.

When dealing with a missed call, the uninformed user often ignores the associated voicemail and takes an incorrect action as a result. Phone users (particularly cell phone users) are notorious for not responding to a voicemail notification by listening to voicemail but rather by instinctively returning the missed call. This method of responding to missed calls is easier and less time consuming than having to enter general voicemail and listen to multiple stored messages of all previous missed calls that resulted in a voicemail. Thus, the user scrolls through the missed call list and simply selects the number to dial and initiate a return call.

The user assumes that the information left on the voicemail (if any) is readily obtainable from the caller when the return call is made to the caller. Often, the caller precedes the subsequent conversation with “did you get my message?” By this inquiry, the caller is hoping the call back is a response to the voicemail and not simply a call back without having first listened to the voicemail. Often a call back is not warranted once the voicemail is listened to and/or the call back requires the user provide some information requested in the voicemail in the subsequent call back.

Thus, while from the perspective of the user, it is more efficient to return the missed call than to “waste” time listening to a sequential list of voicemails that may or may not be associated with the missed call, the caller may be frustrated that the user did not take the time to listen to the voicemail before the user calls back. From the caller's perspective, the effort taken to leave the voicemail was wasted, and the response desired of the callee was not the response received. Also, the caller may not actually leave a voicemail of relevance, other than a message for the user to return the call. Of course, the caller is only able to leave this information via spoken voicemail and thus may simply hope the user calls him/her back, regardless of whether the user accesses the voicemail before initiating the return call.

### SUMMARY OF THE INVENTION

Disclosed is a method, system and computer program product for enhancing a phone device such as a cell phone by linking caller-provided directives/information with voicemail notification so that the phone user (called party or “callee”) is immediately aware what specific response is requested by the caller to the voicemail. Existing voicemail and/or missed call utilities are enhanced with caller-directive options that may be selected by the caller when (before, during or after) the voicemail is being left by the caller. The directives indicate what response the caller requests be provided to the missed call/voicemail by the called party.

In one embodiment, example directives may include: call urgency directives (urgent, not urgent); sequence of response directives (listen to voicemail before returning call, return call a.s.a.p. regardless of voicemail); time for response directive (return call between 3:00 pm and 6:00 pm); and other caller/callee defined directives. In one embodiment, callee or caller directives may include voicemail handling post return call directives, whereby the caller/callee may (1) set a voicemail (that is not important) to be automatically deleted if the user returns the call or (2) set the voicemail to be persistent even after being accessed if the user does not return the call, as a reminder to the user.

According to one embodiment, the caller is prompted to select (or himself initiates selection of) a particular directive to attached to the voicemail. The selection may be from a list of options presented to the caller by the voicemail utility or pre-programmed by the caller while making the call or leaving the voicemail, perhaps by pushing a pre-programmed button on the caller's phone. The caller selects the response required before/while/after recording the voicemail, and the voicemail utility receives the directive and implements processes for carrying out the directives or making the callee aware of the directive. When the phone user (callee) later attempts to access the voicemail, the voicemail utility either initiates the caller's directive or notifies the callee of the desired response (directive).

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1A illustrates an example phone device configured to provide a display of caller-directive with voicemail or missed-call notification functionality according to one embodiment of the invention;

FIG. 1B illustrates one configuration of the internal components of an example phone device configured to support a caller-directive with voicemail or missed call notification according to one embodiment of the invention;

FIGS. 1C and 1D illustrate example legends for icons utilized to indicated caller directives associated with voicemails and/or missed calls according to embodiments of the invention; and

FIGS. 2A and 2B are flow charts of the caller and callee processes by which the voicemail directive and auto-response features of the invention are implemented according to embodiments of the invention.

### DETAILED DESCRIPTION OF AN ILLUSTRATIVE EMBODIMENT

The present invention provides a method, system and computer program product for enhancing a phone device such as a cell phone by linking caller-provided directives/information with voicemail notification so that the phone user (called party or “callee”) is immediately aware what specific response is requested by the caller to the voicemail. Existing voicemail and/or missed call utilities are enhanced with caller-directive options that may be selected by the caller when (before, during or after) the voicemail is being left by the caller. The directives indicate what response the caller requests be provided to the missed call/voicemail by the called party.

In one embodiment, example directives may include: call urgency directives (urgent, not urgent); sequence of response directives (listen to voicemail before returning call, return call a.s.a.p. regardless of voicemail); time for response directive (return call between 3:00 pm and 6:00 pm); and other caller/callee defined directives. In one embodiment, callee or caller directives may include voicemail handling post return call directives, whereby the caller/callee may (1) set a voicemail (that is not important) to be automatically deleted if the user returns the call or (2) set the voicemail to be persistent even after being accessed if the user does not return the call, as a reminder to the user.

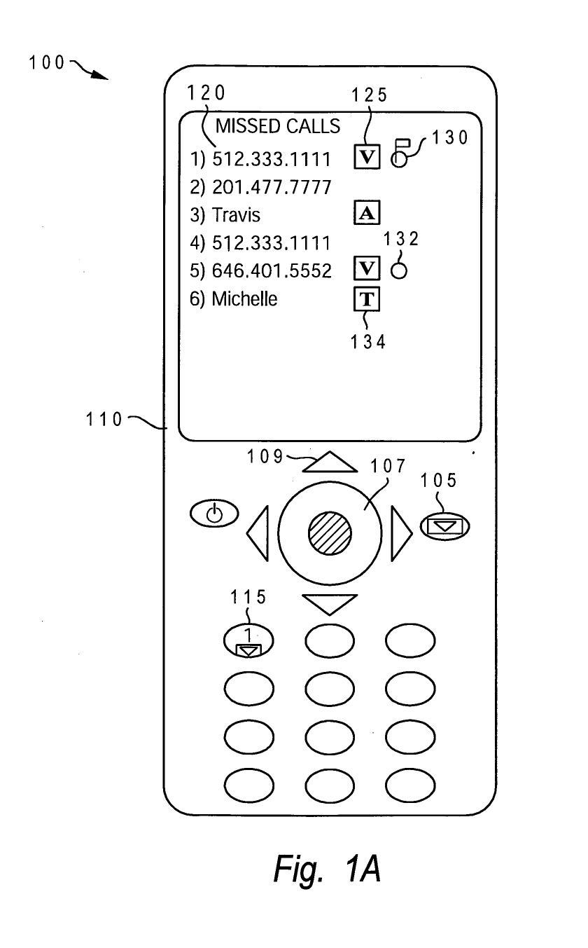

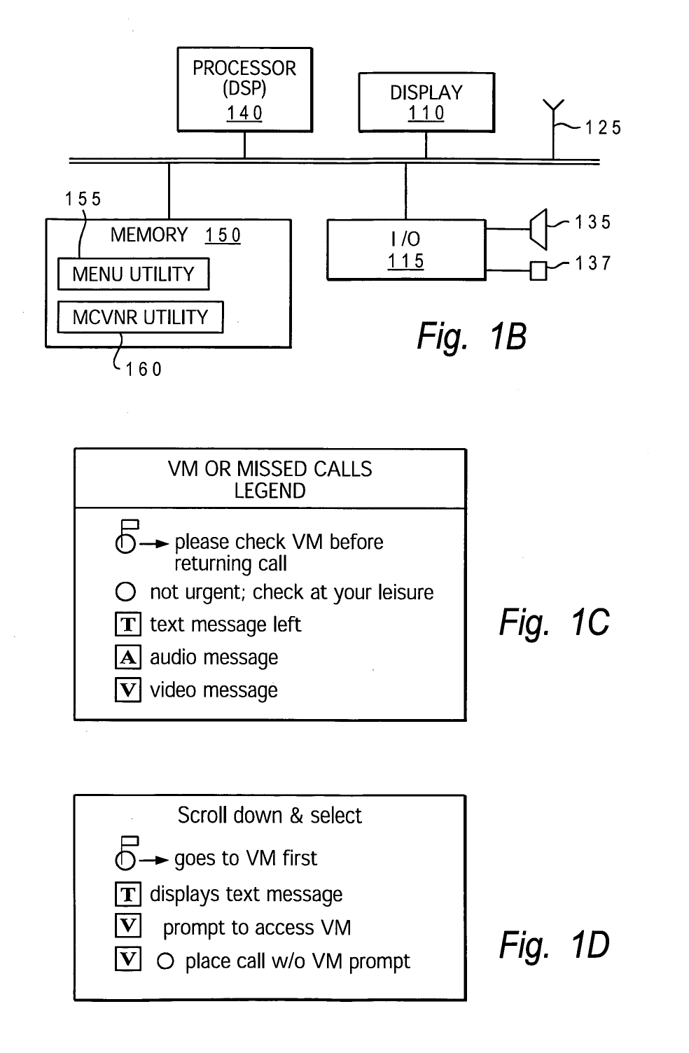

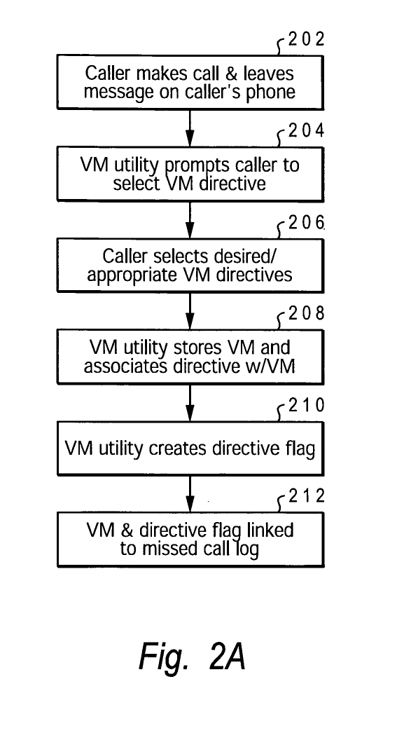

Referring now to the figures and in particular to FIG. 1A, wherein is provided an illustration of a phone device configured with caller voicemail-directive functionality, in accordance with the invention. As shown, cell phone 100 comprises display 110 and numeric keypad 115 and function keypad 107 and selection buttons 109. Additionally, cell phone 100 comprises a voicemail key 105, which when depressed enables access to the voice mailbox and/or voicemail features, including those described herein. Display 110 is illustrated with a plurality of caller-directive/response icons 130, 132, 134 utilized as described below. FIG. 1A also illustrates a missed call log within which is presented missed-call numbers 120 and voicemail notification icons 125, utilized to provide the functionality described in the related, co-pending patent application, Ser. No. 10/______.

FIG. 1B illustrates internal components (hardware and software utility) of an example cellular phone device (cell phone) 100 within which the various features of the invention are advantageously implemented, according to one embodiment. For purposes of the illustration, the features described herein are described as being implemented within a cell phone 100 but is equally applicable to other types of phones (land-line/PSTN phones) that provide electronic missed call logs and digital voicemail notification services.

FIG. 1B illustrates an example configuration of phone device 100 complete with functional components required to provide the features of the invention. Phone device 100 is assumed to be a programmable device with processing/programming functionality. Thus phone device 100 comprises a processor (or CPU) 140 coupled to memory 150 via a bus interface 145. Also coupled to bus interface 145 are display device 110, an I/O device 115 (including numeric and function-keys keyboard), speaker 135 and microphone 137.

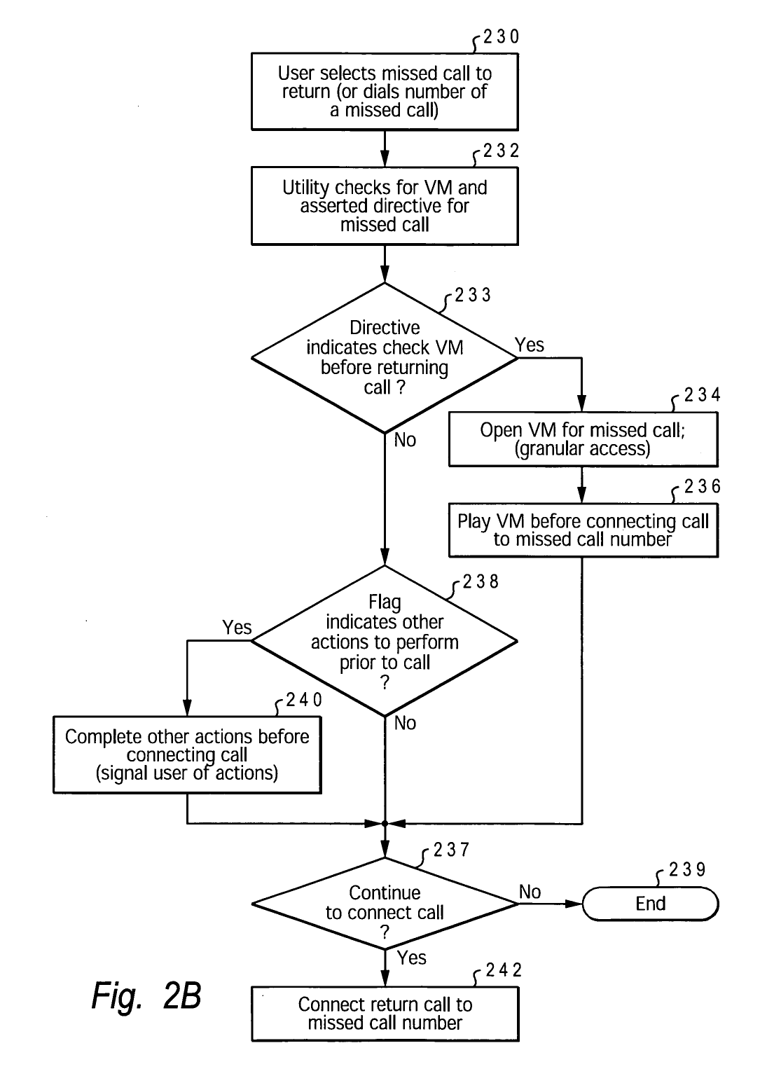

Located within memory 150 and executed on processor 140 are software utilities, including menu utility 155, and missed call and voicemail caller-directive and response (MCVDR) utility 160. MCVDR utility 160 is illustrated as a separate component from menu utility 155, but may be a sub-component of menu utility 155. When executed, menu utility 155 enables access to the standard menu options found in programmable phones, such as voicemail setup and access, display of call logs, and others. According to the invention, MCVDR utility 160 comprises the functionality to link voicemails to particular callers and associate specific caller directives with the recorded voicemail, and other features/functionality described below and as illustrated by FIG. 2.

In one embodiment, function-keys of I/O device 115 includes at least one menu button and/or a voicemail button that enables user-access to functionality provided by a voicemail utility and a missed call utility, which may both be accessible via a menu utility. In one embodiment, I/O device 115 includes a new selectable MCVDR button 115, which enables setup and or activation of an MCVDR utility, described below.

In one embodiment, the MCVDR utility is pre-programmed into the phone, and thus the phone is bought off-the-shelf with this pre-programmed functionality. In another embodiment, using more advanced phone devices/mechanisms, the functionality is programmed (i.e., the utility is uploaded) into the phone post-manufacture by the end user or service provider. The cell phone is initially programmed with the standard voicemail and call log features. The user then upgrades (via direct download from a website, software product, or from the phone service provider) the phone device's software to include code that enables MCVDR utility. This latter embodiment applies to any digitally programmable phones, which are capable of being enhanced with a later-added software package on a desktop computer (or similar device) supporting VOIP operation.

FIGS. 1C and 1D illustrate legends associated with icons provided within display 110 of cell phone 100 of FIG. 1, within which voicemail notification icons and caller directive icons are presented along with a missed (or received) call log, according to now described embodiments of the invention. Turning to FIGS. 2A and 2B, there are illustrated the flow charts of the processes for completing the functional features of the MCVDR utility, from the caller's perspective and from the callee's perspective.

FIG. 2A illustrates the process by which the caller is able to direct (or provide an indication of) the response required/requested by the callee to a voicemail message (or missed call) left on the callee's device. According to one embodiment, the caller is prompted to select (or himself initiates selection of) a particular directive to attached to the voicemail. The selection may be from a list of options presented to the caller by the voicemail utility or pre-programmed by the caller while making the call or leaving the voicemail, perhaps by pushing a pre-programmed button on the caller's phone. The caller selects the response required before/while/after recording the voicemail, and the voicemail utility receives the directive and implements processes for carrying out the directives or making the callee aware of the directive. When the phone user (callee) later attempts to access the voicemail, the voicemail utility either initiates the caller's directive or notifies the callee of the desired response (directive).

At FIG. 2A, the process begins at block 202 with the caller leaving a voicemail on the phone device of the callee. Then, the voicemail utility prompts the caller at block 204 to tag voicemail with the desired response required. According to the illustrative embodiment, the caller is able to indicate his/her intentions by selecting a pre-established (or custom) flag from the voicemail system to send along with the voice mail notification. This flag is then utilized by the phone device to take the appropriate action. In one embodiment, the caller selects the flag from a VRU GUI (graphical user interface) menu of available options, as shown at block 206. In another embodiment, the flag may be selected as an option from a voice mail system or phone that does not have VRU GUIs enabled. This enables the functionality to be implemented with legacy phones and voice mail systems. Other options for flags include custom flags and associated actions specified by the voice mailbox owner (callee) and custom flags and actions specified by the caller.

As partially shown within FIGS. 1C and 1D, among the flags provided, possible flags may include flags that indicate the following directives (or variations thereof):

(1) “please listen to the message before returning the call”. When this directive is provided, upon attempting to return the call, the phone device would complete one or more of the following actions: (a) prompt the user (audibly or visibly on the GUI) to first listen to the message before returning the phone call; (b) automatically forward the user directly to the voicemail; (c) perform a fine-grain voice mail access for that particular voicemail message; and other functions.

(2) “Emergency: please return this call immediately”. This action is customizable, but may include, for example: (a) alert functions that make an audible (or vibrating) alert despite the callee's current phone settings: (b) prompt the user immediately (audible or visibly) to return the call.

(3) “simply return this call . . . the voicemail message is not important.” In one embodiment, this option may further include a feature by which the associated voicemail is deleted after the call is returned (caller number dialed and aswered), whether or not the voicemail is actually listened to.

(4) “please return call within a range of time coordinates,” (e.g., please return call after 3:00 PM today but before 6:00 PM. Automatic time zone adjustments (callee to caller) may be provided with this option to enable correct synchronization of times across different time zones of the caller and callee. According to one related embodiment, if the called party attempts to return the call before the time window has started, the phone utility alerts the called party that the return call is not timely. Also, in another embodiment, the phone monitors for the end of the time period (range) and when the end of the time range is approaching, the phone device prompts the user to return the call (via an audible, visible, or other form of notification).

Returning to FIG. 2, once the specific flag(s) is/are selected, the voicemail utility stores the voicemail with the appropriate directive, as stated at block 208. Then the utility generates a flag that corresponds to the particular directive and links the flag to the voicemail at block 210 before linking the voicemail and the flag to the missed call within a log of missed calls, as indicated at block 212. These latter links to missed calls and missed calls log enables the called party to be notified by simply looking at the missed call or missed call log what the flagged status is of any voicemail left by the missed call. An extension of this functionality is more completely described in the related patent application, Ser. No.______, whose content is incorporated above.

The above described method enables the phone to aid the phone user in taking the correct action when dealing with a missed call. Other advantages include: (1) enhances the user's experience and saves time and effort for both the caller and the callee in setting up and responding to voicemails and/or missed calls; and (2) saving of airtime for both the user and the service provider if the message is conveyed in an appropriate fashion, which ultimately results in cost savings to the user.

In one embodiment, after a call is placed, but before the call is connected, the phone's call connection utility pings the voicemail server and verifies that there are no pending voicemail messages from that number about to be dialed. If there is no voicemail from the number being called, no action is taken/required. If, however, there is a voicemail received from the number being called, the phone's user is either prompted with an indication that a voicemail exists or (depending on the caller's directive) is sent directly to voicemail to first listen to the voicemail from the call number.

FIG. 2B illustrates the process by which the called party (the callee or phone's user) is alerted of the flag and other actions taken by the callee and/or the utility on the callee's phone device in response to the caller-directive flag, according to one embodiment. The process begins at block 230 with the user selecting a missed call or placing a call to the missed call number that has a pending flagged voicemail, which has not yet been listened/responded to. The voicemail response utility checks the flag at block 232 for the specific directive requested by the callee to that voicemail/missed call.

The utility determines at block 233 whether the flag indicates that the voicemail should be listened to before returning the call. If yes, then the voicemail utility automatically accesses the specific voicemail for the missed call as shown at block 234, and the utility plays the voicemail before initiating the call back as shown at block 236. If the flag does not so indicate, however, the utility checks at block 238 for other actions that may be indicated by the flag and performs those actions at block 240. These actions may be any one or more of the above listed response actions enabled by caller's selection of one or more of the specific flag(s) available to the caller or customized by the caller/callee, as described above. Then, assuming the caller initiated a return call, the phone device completes the connection to the caller's number as shown at block 242.

As a final matter, it is important that while an illustrative embodiment of the present invention has been, and will continue to be, described in the context of a fully functional computer system with installed management software, those skilled in the art will appreciate that the software aspects of an illustrative embodiment of the present invention are capable of being distributed as a program product in a variety of forms, and that an illustrative embodiment of the present invention applies equally regardless of the particular type of signal bearing media used to actually carry out the distribution. Examples of signal bearing media include recordable type media such as floppy disks, hard disk drives, CD ROMs, and transmission type media such as digital and analogue communication links.

While the invention has been particularly shown and described with reference to a preferred embodiment, it will be understood by those skilled in the art that various changes in form and detail may be made therein without departing from the spirit and scope of the invention.

What is claimed is:

1. In a communication device, a method comprising:
first receiving from a caller a phone call that is not answered when received, resulting in a missed call at the communication device;
proximately receiving from the caller a directive that indicates a manner by which the caller requires the missed call to be responded to by the user of the communication device (callee); and
subsequently prompting the callee to provide a specific response that complies with the caller's directive.

2. The method of claim 1, wherein:
the missed call results in a voicemail from the caller;
said directive received from the caller indicates the manner by which the caller requires the voicemail be responded to; and
said subsequently prompting further comprising prompting the callee to provide the specific response to the recorded voicemail.

3. The method of claim 2, wherein the specific directive is one or more of:
an action directive that indicates the action required from the callee, said action being selected from a plurality of actions from among: returning the phone call to the caller without necessarily listening to the voicemail; listening to voicemail before returning the phone call; and perform a specific, custom caller action that is predefined by the caller; and perform a specific, custom callee action that is predefined by the callee and made available for selection by the callee's phone device to the caller;
a time of response directive that indicates the time the caller wishes the call to be returned, said time of response directive having one or more of: a start/earliest time after which the callee should return the call; an end/latest time before which the callee should return the call; and a range of time between which the callee should return the call; and a device control directive, which enables the caller to exercise some control over the device and callee's response by setting the callee's device to perform pre-set functions in a particular order, said device control directives selected from among: direct callee to recorded voicemail before enabling a return call to the caller's number; and delete a recorded voicemail that is not important after the callee returns the call to the caller.

4. The method of claim 1, wherein when the user of the communication device is the caller, who originates the call, the method further comprises:
placing a call to a next party having a device that accepts caller directives; and
when the call is unanswered by the next party, associating with the call a particular directive, from among: (a) a first directive that indicates the action desired by the caller from the next party in response to voicemail left by the caller; (2) a second directive that indicates the action desired by the caller from the next party in response to the missed call; and (3) a third directive that indicates the action desired by the caller from the next party's device in response to one of a voicemail and a missed call recorded by the next party's device.

5. The method of claim 4, further comprising selecting the particular directive from a list of directives available at the caller's phone.

6. The method of claim 4, further comprising selecting the particular directive from a list of directives available at the next party's device and played to the caller proximate to the time of recording of the voicemail.

7. The method of claim 1, wherein the communication device is a device that provides cellular communication capabilities.

8. A computer program product having program code stored on a computer readable medium that when executed by a processor of a communication device completes the steps of claim 1.

9. A method for providing enhanced cellular phone service, said method comprising loading on a cellular phone device program code for performing the steps described in claim 1 when executed by a processor of the phone device.

10. In a communication device, a method comprising:
placing a call to a callee having a device that accepts caller directives; and
when the call is unanswered by the callee, associating with the call a particular directive, from among: (a) a first directive that indicates the action desired by the caller from the callee in response to voicemail left by the caller; (2) a second directive that indicates the action desired by the caller from the callee in response to the missed call; and (3) a third directive that indicates the action desired by the caller from the callee's device in response to one of a voicemail and a missed call recorded by the callee's device.

11. The method of claim 10, further comprising selecting the particular directive from a list of directives available at the caller's phone.

12. The method of claim 10, further comprising selecting the particular directive from a list of directives available at the callee's phone and played to the caller proximate to the time of recording of the voicemail.

13. A cellular communication device comprising:
a processor; and
program code that when executed by the processor performs the functions of:
first receiving from a caller a phone call that is not answered when received, resulting in a missed call at the communication device;
proximately receiving from the caller a directive that indicates a manner by which the caller requires the missed call to be responded to by the user of the communication device (callee); and
subsequently prompting the callee to provide a specific response that complies with the caller's directive.

14. The device of claim 13, wherein:
the missed call results in a voicemail from the caller;
said directive received from the caller indicates the manner by which the caller requires the voicemail be responded to; and
said code for subsequently prompting further comprising code for prompting the callee to provide the specific response to the recorded voicemail.

15. The device of claim 14, wherein the specific directive is one or more of:
an action directive that indicates the action required from the callee, said action being selected from a plurality of actions from among: returning the phone call to the caller without necessarily listening to the voicemail; listening to voicemail before returning the phone call; and perform a specific, custom caller action that is predefined by the caller; and perform a specific, custom callee action that is predefined by the callee and made available for selection by the callee's phone device to the caller;
a time of response directive that indicates the time the caller wishes the call to be returned, said time of response directive having one or more of: a start/earliest time after which the callee should return the call; an end/latest time before which the callee should return the call; and a range of time between which the callee should return the call; and
a device control directive, which enables the caller to exercise some control over the device and callee's response by setting the callee's device to perform pre-set functions in a particular order, said device control directives selected from among: direct callee to recorded voicemail before enabling a return call to the caller's number; and delete a recorded voicemail that is not important after the callee returns the call to the caller.

16. The device of claim 13, wherein when the user of the communication device is the caller, who originates the call, the code further comprises code for:
placing a call to a next party having a device that accepts caller directives; and
when the call is unanswered by the next party, associating with the call a particular directive, from among: (a) a first directive that indicates the action desired by the caller from the next party in response to voicemail left by the caller; (2) a second directive that indicates the action desired by the caller from the next party in response to the missed call; and (3) a third directive that indicates the action desired by the caller from the next party's device in response to one of a voicemail and a missed call recorded by the next party's device.

17. The device of claim 16, further comprising code for selecting the particular directive from a list of directives available at the caller's phone.

18. The device of claim 16, further comprising code for selecting the particular directive from a list of directives available at the next party's device and played to the caller proximate to the time of recording of the voicemail.
